(19) United States
(12) Patent Application Publication
(10) Pub. No.: US 2025/0249389 A1
(43) Pub. Date: Aug. 7, 2025

(54) FILTER APPARATUS

(71) Applicant: MANN+HUMMEL GmbH, Ludwigsburg (DE)

(72) Inventors: Johannes GRAD, Simbach (DE); Matthias STARZER, Landau an der Isar (DE); Robert GÜNTNER, Reisbach (DE); Laura DEL RIO, Longares (ES); Juan Antonio CABANES CACHO, Zaragoza (ES)

(21) Appl. No.: 19/186,898

(22) Filed: Apr. 23, 2025

Related U.S. Application Data
(63) Continuation of application No. PCT/EP2023/080834, filed on Nov. 6, 2023.

(30) Foreign Application Priority Data
Nov. 8, 2022 (DE) 102022129489.7

(51) Int. Cl. B01D 46/12; B01D 46/00; B01D 46/64

(52) U.S. Cl. CPC B01D 46/12; B01D 46/0005; B01D 46/64; B01D 2265/05

(57) ABSTRACT

A filter apparatus has a first filter element with first filter medium body and first seal surrounding the latter and a second filter element with second filter medium body and second seal surrounding the latter. A filter housing has a first housing part with filter element receptacle in which the first filter element is arranged and further has a first circumferential housing seal surface at which the first seal rests seal-tightly. An adapter frame has a filter element receptacle in which the second filter element is arranged. The adapter frame has a first circumferential seal surface at which the second seal rests seal-tightly. The adapter frame has a second circumferential seal surface at which the first seal rests seal-tightly. A second housing part has a second circumferential housing seal surface at which the second seal rests seal-tightly. A method of using the filter elements in the filter apparatus is provided.

### CROSS-REFERENCE TO RELATED APPLICATIONS

This application is a continuation application of international application No. PCT/EP2023/080834 having an international filing date of Nov. 6, 2023, and designating the United States, the international application claiming a priority date of Nov. 8, 2022, based on prior filed German patent application No. 10 2022 129 489.7, the entire contents of the aforesaid international application and the aforesaid German patent application being incorporated herein by reference.

### BACKGROUND

The present invention concerns a filter apparatus, for example of a cabin air filter system or of an intake air filter system of a fuel cell. Furthermore, the invention concerns the use of filter elements in such a filter apparatus.

The interior air flowing into a vehicle cabin is freed as completely as possible from contaminants. Possibly occurring contaminants are, for example, particulate matter, pollen, soot or aerosols. In applications in which high concentrations of plant protection agents or liquid fertilizer agents are present in the ambient air when using spray devices for dispersing these substances, filtering of such contaminants is important. For this purpose, various filter media are available. Usually, particle filters, active carbon filters, and HEPA filters are used, for example. They are combined in various layers and various arrangements in order to obtain the desired filtration effect for the interior air.

Since in practice combinations of very different pollutants to be separated occur, the use of multi-stage filter systems or filter elements has been established.

In addition to the use of multi-stage filter systems or filter elements in the field of cabin air filtration, the filtration of the supply air for a fuel cell system represents a further field of use because here likewise high requirements are posed regarding the purification of the air with respect to particle filtration and harmful gas separation. Furthermore, a use of such multi-stage filter systems or filter elements in hydrogen-operated combustion engines is conceivable.

EP 2 939 725 A1 discloses a cabin air filter element that includes two filter medium bodies which may be flowed through in series and of which one represents a gas filter stage and another one a particle filter stage, for example with HEPA efficiency. In one state of use, the cabin air filter element is used in a filter housing fixed in a vehicle and flowed through by air laden with contaminants. A disadvantage of this is that the filter medium bodies of the gas filter stage and of the particle filter stage cannot be exchanged independent from each other because they are connected non-detachably to each other, for example glued into a common frame. This, inter alia, results in an incomplete utilization of the separation capacity of one of the filter medium bodies.

Furthermore, EP 3 453 443 A1 discloses an intake air filter comprising a filter element that includes a filter medium body of a folded particle filter medium. The filter element includes furthermore a circumferentially extending seal with which it is inserted seal-tightly into a filter housing so that an inlet side and an outlet side of the filter housing are separated by the filter element. The intake air filter described therein includes only one filter stage and does not allow for harmful gas separation.

A filter element or filter insert is in general understood as inserts which, as a unit, are exchangeably arrangeable in a filter housing and which include at least one filter medium body of a filter medium, frequently in the form of a folded filter bellows, and usually also a structure supporting or carrying the filter medium and usually also a seal. The respective filter medium includes usually a limited service life for which reason filter elements must be exchanged regularly.

### SUMMARY

In view of this background, it is the object of the present invention to provide an improved filter apparatus which permits to further develop an existing—for example single-stage—filter system to a multi-stage filter system, wherein the filter elements of the individual filter stages may be exchanged independent of each other.

This object is solved by a filter apparatus, for example of a cabin air filter system or of an intake air filter system of a fuel cell, including: at least two filter elements, each comprising a filter medium body and a seal circumferentially extending around the latter; and a filter housing with at least two housing parts, wherein a first housing part includes a filter element receptacle in which a first filter element is arranged, and wherein the first housing part includes at least one circumferentially extending housing seal surface at which a circumferentially extending seal of the first filter element rests seal-tightly; an adapter frame comprising a filter element receptacle in which a second filter element is arranged, wherein the adapter frame includes at least a first circumferentially extending seal surface at which a circumferentially extending seal of the second filter element rests seal-tightly, and wherein the adapter frame includes additionally a second circumferentially extending seal surface at which the circumferentially extending seal of the first filter element rests seal-tightly; and wherein a second housing part includes a circumferentially extending housing seal surface at which the circumferentially extending seal of the second filter element rests seal-tightly.

The object is further solved by a use of a filter element including: a filter medium body and a seal circumferentially extending around the filter medium body as a first filter element in a filter apparatus according to the invention; wherein the circumferentially extending seal contacts seal-tightly the second seal surface of the adapter frame, and wherein the circumferentially extending seal contacts seal-tightly the circumferentially extending housing seal surface of the first housing part.

The object is further solved by a use of a filter element including: a filter medium body and a seal circumferentially extending around the filter medium body as a second filter element in a filter apparatus according to the invention; wherein the circumferentially extending seal contacts seal-tightly the first seal surface of the adapter frame, and wherein the circumferentially extending seal contacts seal-tightly the circumferentially extending housing seal surface of the second housing part.

Further embodiments of the invention as well as exemplary embodiments of the invention are described in the following.

The filter apparatus according to the invention is for example designed for use in a cabin air filter system or in an intake air filter system of a fuel cell. The filter apparatus includes at least two filter elements which each include a filter medium body and a seal surrounding the filter medium body. Furthermore, the filter apparatus includes a filter housing with at least two housing parts, wherein a first housing part includes a filter element receptacle in which a first filter element is arranged. The first housing part includes at least one circumferentially extending housing seal surface at which a circumferentially extending seal of the first filter element rests seal-tightly. Furthermore, the filter apparatus includes an adapter frame comprising a filter element receptacle in which a second filter element is arranged. The adapter frame includes at least a first circumferentially extending seal surface at which a circumferentially extending seal of the second filter element rests seal-tightly and has furthermore a second circumferentially extending seal surface at which the circumferentially extending seal of the first filter element rests seal-tightly. A second housing part of the filter apparatus includes a circumferentially extending housing seal surface at which the circumferentially extending seal of the second filter element rests seal-tightly.

The filter elements of the filter apparatus according to the invention may be provided as exchangeable components which may be replaced in a service situation, i.e., upon reaching their maximum separation capacity.

Due to the use of the adapter frame, the present invention makes it possible to further develop an existing single-stage filter system to a two-stage or multi-stage filter system by simple measures. The adapter frame provides in this context the receptacle for an additional filter element and enables sealing of the two or more filter elements in relation to the two housing parts. The two filter elements of the filter apparatus according to the invention may be separately exchangeable so that the separation capacity of both filter elements may be utilized optimally. In other words, the adapter frame provides an intermediate piece which is located between the two filter elements in the mounted state. The first filter element in this context is sealed directly in relation to the first housing part and the second filter element is sealed directly in relation to the second housing part. Among each other, the two filter elements are sealed however by the adapter frame. In order to enable this, the adapter frame includes a circumferentially extending fluid-tight wall which is connected to first and second circumferentially extending seal surfaces.

The adapter frame may be a separate part and coupled to the filter elements so as not to be attached or only detachably attached to them. The adapter frame may be removed from the filter apparatus for exchange of the filter elements.

In various embodiments, the circumferentially extending seal of the filter elements may comprise or be comprised of a plastic material, for example a foamed polyurethane or a thermoplastic elastomer. The aforementioned materials may be provided in a liquid or pasty initial state and, with the aid of a casting mold, may be formed in an inventive manner directly by material fusion to the filter medium bodies. In the casting mold, the seal base material provided in a liquid or pasty initial state cures and forms thereafter the final material of the circumferentially extending seal.

The filter elements each may have precisely four side faces and/or a cuboid basic shape. As an alternative, they may however also have the shape of any polygon or have curved edges at least in sections and/or have a circular shape or elliptical shape.

The first and the second filter elements may be flowed through in series in the direction of a predetermined flow direction so that either first the first filter element and then the second filter element, or first the second and then the first filter element are flowed through.

The filter medium body of the filter elements may include a filter medium folded multiple times so that the filter medium body may be a filter bellows. A fold distance of the filter bellows may lie, for example, between 3 and 5 mm and a fold height between 20 and 30 mm. In embodiments, 30 to 300 folds may be present. Alternatively, the filter medium body may also include a filter medium that is present in an unfolded state, for example, in the form of a foam or other porous material, or honeycomb body. Furthermore, the filter medium body may be in the form of a combination of flat and corrugated layers of filter medium, i.e., as a so-called compact filter.

The filter elements of the filter apparatus according to the invention may be comprised completely of thermally recoverable materials so that there are no disposal problems and disassembly of individual components of the filter elements is not required in the recovery process.

An axial direction and a radial direction of the filter apparatus or the filter elements is referred to herein, wherein “axial” means in the flow direction, i.e., perpendicularly to an inflow surface or inflow side of the filter element, and wherein “radial” is understood as a normal direction of a side face or wall of a frame or of a lateral surface of the filter element. The radial direction extends normal to the axial direction.

The respective filter medium body may include a filter medium which, for example, is a filter fabric, a laid filter or a filter nonwoven. The filter medium may be produced by a spunbond or melt-blown method. Furthermore, the filter medium may be felted or needled. The filter medium may include natural fibers such as cotton or synthetic fibers, for example, of polyester, polyphenyl sulfide or polytetrafluoroethylene.

It may be provided that the first and the second filter elements are sealed indirectly through the adapter frame in relation to the at least two housing parts. In other words, the second filter element has a direct seal location in relation to the second housing part, but no direct seal location in relation to the first housing part. The first filter element, in turn, has a direct seal location in relation to the first housing part, but not a direct seal location in relation to the second housing part. The sealing action of the two filter elements in relation to the two housing parts is realized thus by means of interposition of the adapter frame which, on the one hand, seals the two filter elements relative to each other and, on the other hand, transmits seal pretension forces. In order to be able to transmit the seal pretension forces, the circumferentially extending fluid-tight wall of the adapter frame must be designed appropriately with respect to its stiffness by skilled action of the artisan.

According to a further embodiment, the first circumferentially extending seal surface of the adapter frame and the second circumferentially extending seal surface of the adapter frame may be spaced apart from each other in axial direction and oriented so as to face away from each other. The axial distance of the first and second seal surfaces of the adapter frame corresponds to a distance of the circumferentially extending seals of the two filter elements in their mounted state. The first circumferentially extending seal surface of the adapter frame may be in sealing contact at a bottom side of the circumferentially extending seal of the second filter element while the second circumferentially extending seal surface of the adapter frame may be in sealing contact at a top side of the circumferentially extending seal of the first filter element. The terms “top side” and “bottom side” relate in this context to the direction of gravity for mounting of the filter apparatus as intended.

According to yet another embodiment, it may be provided that the adapter frame, neighboring its first and/or second seal surface, includes a radially outwardly displaced, at least partially circumferentially extending collar section, which extends in axial direction and which delimits at least partially a receptacle chamber for the circumferentially extending seal of the first and/or second filter element. The collar section limits, on the one hand, a deformation of the circumferentially extending seal of the first and/or second filter element in radial direction and, on the other hand, provides a protective action for the circumferentially extending seal so that the latter is protected from mechanical damages and it may be prevented that dirt reaches the seal contact.

Furthermore, the circumferentially extending seal of the first and/or second filter element may include a seal profile that protrudes radially past the filter medium body of the first and/or second filter element. The seal profile is the component of the circumferentially extending seal where the actual sealing action takes place. The seal profile may be an axially acting seal profile in embodiments.

In this context, it may be provided that the at least partially circumferentially extending collar section of the adapter frame projects past the seal profile in axial direction. In this way, the protective action already mentioned herein is further improved.

According to a further embodiment, it may be provided that the at least partially circumferentially extending collar section of the adapter frame extends at an acute angle in relation to the axial direction. In this way, on the one hand, mounting is facilitated because the angularly oriented collar section serves as a mounting ramp, on the other hand, at the angularly oriented collar section a combined radial-axial sealing action may be realized, which improves the sealing action.

According to a further embodiment, the first housing part may be a housing base part and the second housing part may be a removable housing cover. In a state of use of the filter apparatus as intended, the housing base part may be arranged at the very bottom so that, viewed away from the housing base part in axial direction, the first filter element, the adapter frame, the second housing part, and finally the housing cover follow the housing base part. In the state of use as intended, the housing base part may be arranged for example at the bottom in the direction of gravity while the housing cover may be arranged at the top in the direction of gravity.

In an embodiment, the first filter element may be exchangeable by removing the housing base part from below and the second filter element exchangeable by removing the housing cover from above. Here, “below” and “above” relate to an arrangement of the filter housing as intended in the state of use in relation to the direction of gravity. A simple and fast filter element service may be performed in this way even in tight installation space conditions.

According to yet another embodiment, the seal profile of the circumferentially extending seal of the first filter element may include a circumferentially extending groove at whose groove bottom the circumferentially extending housing seal surface of the first housing part rests. In other words, the circumferentially extending groove of the seal profile of the circumferentially extending seal of the first filter element accommodates a wall section of the first housing part which includes the circumferentially extending housing seal surface of the first housing part. Due to the contact of the circumferentially extending housing seal surface of the first housing part at the groove bottom of the groove of the seal profile of the circumferentially extending seal of the first filter element, seal pretension forces are transmitted and the seal profile is supported in radial direction so that the latter cannot deform in an uncontrolled manner under the effect of the seal pretension forces.

Furthermore, the seal profile of the circumferentially extending seal of the second filter element may comprise a circumferentially extending groove at whose groove bottom the first circumferentially extending seal surface of the adapter frame rests. In other words, the circumferentially extending groove of the seal profile of the circumferentially extending seal of the second filter element accommodates a wall section of the adapter frame which includes the first circumferentially extending seal surface of the adapter frame. Due to the contact of the first circumferentially extending seal surface of the adapter frame at the groove bottom of the groove of the seal profile of the circumferentially extending seal of the second filter element, seal pretension forces are transmitted and the seal profile is supported in radial direction so that the latter cannot deform in an uncontrolled manner under the effect of the seal pretension forces.

As an alternative or in addition, the seal profile of the circumferentially extending seal of the first filter element may include an axial seal surface which is facing away from the circumferentially extending groove and at which the second seal surface of the adapter frame rests. The directions of action of the first and second seal surfaces of the adapter frame may be oriented opposite to each other.

Furthermore, the seal profile of the circumferentially extending seal of the second filter element may include an axial seal surface facing away from the circumferentially extending groove at which the circumferentially extending housing seal surface of the second housing part rests.

In embodiments, the circumferentially extending seal of the first and/or second filter element may include at least two legs in cross section, namely:
a transverse leg which is connected to an inflow surface or outflow surface of the filter medium body of the respective filter element, and
a longitudinal leg which is connected to a side face of the filter medium body of the respective filter element.

The transverse leg and the longitudinal leg may be connected to the seal profile, for example may be produced as one piece therewith, for example as one piece by means of a casting method.

The legs and the seal profile of the circumferentially extending seal may be produced in a common method step in a single tool (casting mold). The aforementioned legs—transverse leg and longitudinal leg—may also be referred to, in other words, as connecting legs of the circumferentially extending seal because they primarily connect the seal profile to the filter medium body.

According to yet another embodiment, the circumferentially extending seal may be connected directly by material fusion to the filter medium body of the first and/or the second filter element. The direct material-fused connection of the circumferentially extending seal, independent of the embodiment, may be a foamed connection which, for example when using a polyurethane as a starting material, is an established industrial process.

In various embodiments, the filter medium body, for example filter bellows, of the first and/or second filter element may include sealed fold end face edges, for example in the form of a fluid-tight adhesive connection of fold interstices and/or of at least one frame element attached to the fold end face edges. Due to the sealed end face edges, bypassing of the filter medium body of the respective filter element is prevented. The frame element may be a frame element which completely surrounds the filter medium body of the respective filter element, and, alternatively or additionally, may be fluid-tightly connected to the circumferentially extending seal, for example connected thereto by material fusion, for example, foamed around by the surrounding seal.

In a further embodiment, the filter apparatus may include a connection device connecting the first housing part to the second housing part and producing an at least axially oriented pretension force. The adapter frame includes a guide device coupled to the connection device for guiding the connection device in at least one direction normal to the axial direction. The guide device of the adapter frame may be, for example, a through hole or a radially outwardly open guide groove which extends in axial direction and in which the connection device is received. The connection device exerts an axially oriented pretension force for pretensioning the circumferentially extending seals of the first and second filter elements between the first and the second housing parts, wherein the adapter frame is located indirectly in the force flow.

According to an embodiment, it may be provided that the connection device is accessible from the side of the second housing part, for example the housing cover, for example wherein the connection device includes at least one screw which is coupled with a corresponding thread at the first housing part. The present invention is however not limited thereto; instead, the connection device may include also other connection means which appear suitable to a person of skill in the art and which are suitable to produce an at least axially oriented pretension force between the two housing parts.

In embodiments, the filter medium body of at least one of the filter elements may include at least one particle filter medium, for example including a synthetic nonwoven material and/or a cellulose-based filter medium, wherein the particle filter medium fulfills filtration class H13 or H14 according to DIN EN 1822-1. As an alternative or in addition, the filter medium body of at least one of the filter elements may include a gas filter medium, for example including at least an adsorber, for example an active carbon, a zeolite and/or an ion exchanger.

The gas filter medium may also include its own particle filter layer, for example including a synthetic nonwoven material. As an alternative, the gas filter medium may also include only one support layer which immobilizes the adsorber which is present in granular form or in particle form, wherein the support layer may include a nonwoven material with a pore size which is significantly larger in comparison to the particle filter medium.

According to an embodiment, the second filter element may include the gas filter medium. In the state of use as intended of the filter apparatus, the second filter element may be flowed through after the first filter element.

In other words, the filter element including the gas filter medium may be arranged downstream of the filter element that includes the particle filter medium. In this way, an air flow which is passing through the filter apparatus according to the invention may flow first through the filter element including the particle filter medium and subsequently through the filter element including the gas filter medium. This has the advantage that the gas filter medium may be flowed through with air from which particles have been removed, which improves the adsorption performance of the gas filter medium, for example considered over time, because pores of the adsorber of the gas filter medium are not “clogged” with particles.

Furthermore, the particle filter medium and/or gas filter medium may include an antimicrobial and/or anti-allergic action. As an anti-microbial substance, for example, zinc pyrithione or nano silver, as an anti-allergic substance, for example, polyphenol is conceivable.

According to an embodiment, the first housing part and/or the second housing part may be configured to be collapsible for exchange of at least one of the filter elements so that an extension of the respective housing part may be reduced at least in or opposite to the flow direction. In this way, an even further improved filter element service is enabled in tight installation space conditions. Herein, “collapsible” is to be understood in that the respective housing part, for example the housing base part, includes at least one yielding section along which the respective housing part may be pushed together and/or folded along the flow direction. Such yielding sections may be realized by one or a plurality of circumferentially extending material thickness reductions at the wall of the respective housing part so that they essentially form a film hinge, respectively. Alternatively or additionally, the yielding sections may also be formed of a yielding and/or flexible material as the wall of the respective housing part, wherein for this purpose the manufacture in a 2K plastic injection molding process is feasible. However, the yielding sections may be connected to the wall of the respective housing part also in another way, for example, by welding or form-fit fastening means such as clips.

A further aspect of the present invention concerns the use of a filter element, comprising a filter medium body and a seal circumferentially extending around the latter, as a first filter element in a filter apparatus according to the invention. In this context, the circumferentially extending seal rests seal-tightly at the second seal surface of the adapter frame and at the circumferentially extending housing seal surface of the first housing part.

A still further aspect of the present invention concerns the use of a filter element, comprising a filter medium body and a seal circumferentially extending around the latter, as a second filter element in a filter apparatus according to the invention. In this context, the circumferentially extending seal rests seal-tightly at the first seal surface of the adapter frame and at the circumferentially extending housing seal surface of the second housing part.

Possible implementations of the invention include also combinations, not explicitly mentioned, of features described before or in the following in relation to the various embodiments. In this context, a person of skill in the art will also add individual aspects as improvements or supplements to the respective basic shape of the invention.

In the following, the invention will be explained in more detail with the aid of exemplary embodiments with reference to the attached drawing figures.

### BRIEF DESCRIPTION OF DRAWINGS

FIG. 1 is a longitudinal section view of a filter apparatus according to the invention.

FIG. 2 shows detail A according to FIG. 1.

FIG. 3 is a longitudinal section view of a filter apparatus according to the invention.

FIG. 4 shows an isometric view of an adapter frame as well as of a first and second filter element of a filter apparatus according to the invention.

FIG. 5 is a longitudinal section view of a filter apparatus according to the invention according to a further embodiment in an operating state.

FIG. 6 is a longitudinal section view of the filter apparatus according to FIG. 5 in a service state with partially removed first filter element.

FIG. 7 is a longitudinal section view of the filter apparatus according to FIG. 5 in the service state with completely removed first filter element.

### DETAILED DESCRIPTION

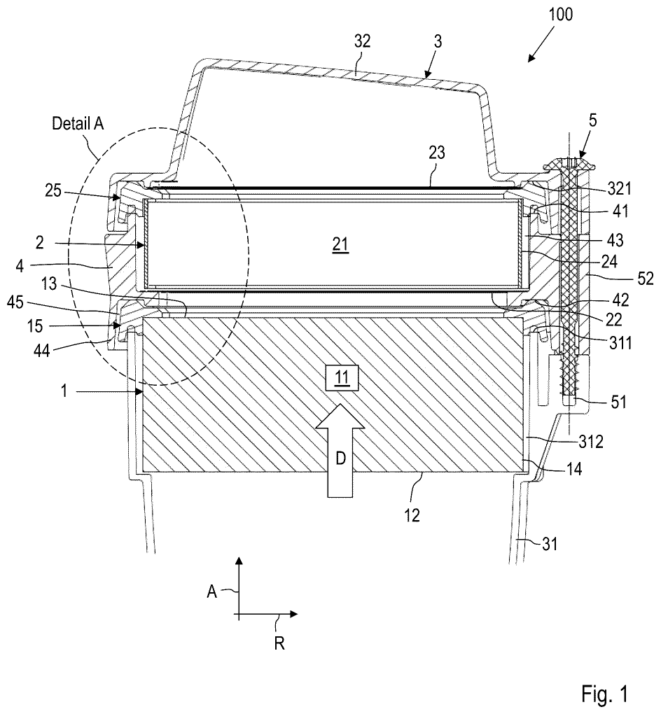

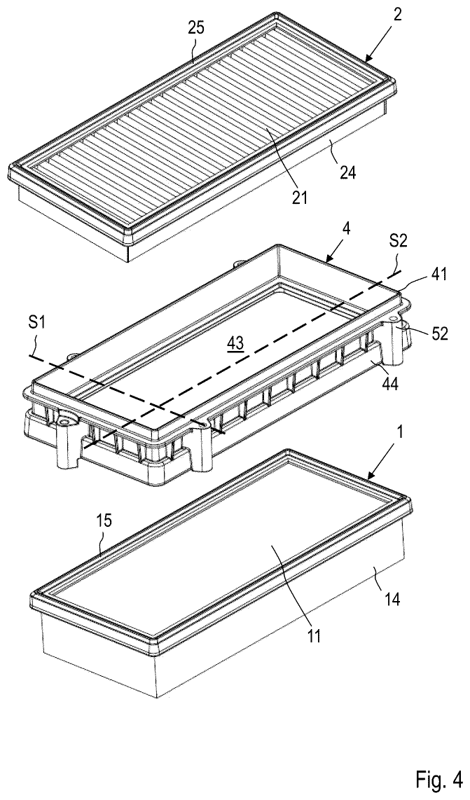

FIG. 1 shows a filter apparatus 100 according to the invention in a longitudinal section view, wherein the section plane S1 on which it is based is indicated in FIG. 4, i.e., the section plane extends parallel to a short side of a filter housing 3. The filter housing 3 comprises a first housing part 31, for example a housing base part 31, as well as a second housing part 32, for example a removable housing cover 32. At the filter housing 3, there is a raw-side inlet, not illustrated, as well as clean-side outlet, not illustrated, wherein two filter elements 1, 2 of the filter apparatus 100 separate the inlet from the outlet.

The filter elements 1, 2 each comprise a filter medium body 11, 21 which comprises a filter medium. The filter medium bodies 11, 21 may comprise a filter medium folded multiple times so that they are filter bellows, respectively.

The two filter elements 1, 2 may be flowed through in series, for example, the first filter element 1 is flowed through in flow direction D before the second filter element 2. The flow direction D extends in or parallel to the axial direction A. An air flow passing through the filter apparatus 100 passes first through an inflow side 12 of the first filter element 1, then the filter medium body 11 of the first filter element 1, and then exits the first filter element 1 at the outflow side 13 of the first filter element 1. During the further course, the air flow passes through an inflow side 22 of the second filter element 2, then the filter medium body 21 of the second filter element 2, and then exits the second filter element 2 at the outflow side 23 of the second filter element 2.

The filter elements 1, 2 each comprise an at least partially circumferentially extending frame 14, 24 that laterally seals the filter medium body 11, 21 of the respective filter element 1, 2. The frame 14 of the first filter element 1 is configured as a seal of fold end face edges of the filter medium body 11 while the frame 24 of the second filter element 2 is configured as a frame element attached to the fold end face edges of the filter medium body 21, for example comprising at least a lateral band and/or head band.

The two filter elements 1, 2 are separate and not connected to each other and seal in relation to the first and the second housing parts 31, 32 indirectly through an adapter frame 4 which is located between them.

The first filter element 1 is received in a filter element receptacle 312 of the first housing part 1 and comprises a circumferentially extending seal 15 which is seal-tightly connected to the filter medium body 11. The circumferentially extending seal 15 of the first filter element 1 rests seal-tightly at an axial end at a circumferentially extending housing seal surface 311 of the first housing part 31. At another axial end, the circumferentially extending seal 15 of the first filter element 1 rests seal-tightly at a second circumferentially extending seal surface 42 of the adapter frame 4.

The second filter element 2 is received in a filter element receptacle 43 of the adapter frame 4 and comprises a circumferentially extending seal 25 which is seal-tightly connected to the filter medium body 21. The circumferentially extending seal 25 of the second filter element 2 seal-tightly rests at an axial end at a first circumferentially extending seal surface 41 of the adapter frame 4. At another axial end, the circumferentially extending seal 25 of the second filter element 2 rests seal-tightly at a circumferentially extending housing seal surface 321 of the second housing part 32.

According to the invention, the two filter elements 1, 2 each have only an indirect seal location in relation to one of the housing parts 31, 32 while the sealing action in relation to the other one of the housing parts 31, 32 is provided indirectly by the adapter frame 4. Thus, the present invention enables a simple further development of an existing single-stage filter system to a multi-stage filter apparatus 100. In order to achieve this, it is advantageous when a cross section of the circumferentially extending housing seal surface 311 of the first housing part 31 corresponds to a cross section of the first circumferentially extending seal surface 41 of the adapter frame 4. Furthermore, it is advantageous when the cross section of the circumferentially extending housing seal surface 321 of the second housing part 32 corresponds to a cross section of the second circumferentially extending seal surface 42 of the adapter frame 4.

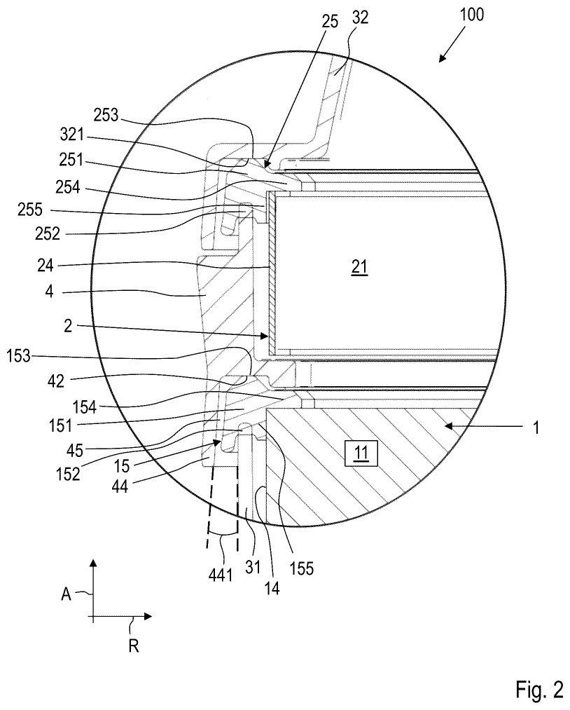

The circumferentially extending seal 15, 25 of the filter elements 1, 2 comprises a seal profile 151, 251 (see FIG. 2) projecting in radial direction R, respectively, at which the actual sealing action takes place. The seal profile 151 of the first filter element 1 is received in a receiving chamber 45 which is present at the adapter frame 4 adjacent to the second seal surface 42. The receiving chamber 45 is radially outwardly delimited by a collar section 44 of the adapter frame 4 which projects past the seal profile 151 of the first filter element in axial direction A. The collar section 44 of the adapter frame 4 limits an accidental deformation of the circumferentially extending seal 15 of the first filter element 1 in radial direction R under the effect of the seal pretension forces acting at least in axial direction A.

The two housing parts 31, 32 are connected by means of at least one connection device 5 comprising a screw 5. The screw 5 is inserted through a through bore of the second housing part 32 and extends farther through a guide device 52 of the adapter frame 4 and is finally coupled to a thread 51 at the first housing part 31. The connection device 5 produces an at least axially (A) oriented pretension force and provides thus the sealing pretension force which is required for sealing the filter elements 1, 2. Distributed about the circumference of the filter housing 3, for example a plurality of screws 5 may be present in order to enable a pretension as uniform as possible of the circumferentially extending seals 15, 25 of the first and second filter elements 1, 2. The guide device 52 of the adapter frame 4 is formed as a through bore wherein the screw is pushed through loosely. The connection device 5 secures the adapter frame 4 in radial direction R relative to the housing parts 31, 32 so that it does not laterally slide even in case of an unauthorized use of the filter apparatus 100. Furthermore, in this way a simple and guided mounting of the screw 5 is enabled. In an arrangement of use of the filter apparatus 100 as intended, the screw 5 is arranged such that it is accessible from the second housing part 32 which is a housing cover.

In FIG. 2, detail A according to FIG. 1 is illustrated wherein the sealing interfaces between the two filter elements 1, 2, the adapter frame 4, and the two housing parts 31, 32 is readily seen.

The circumferentially extending seals 15, 25 of the two filter elements 1, 2 each comprise a longitudinal leg 155, 255 connected to the side faces or the frame 14, 24 of the filter medium body 11, 21 of the respective filter element 1, 2. Furthermore, the circumferentially extending seals 15, 25 of the two filter elements 1, 2 each comprise a transverse leg 154, 254 which is connected to an inflow surface or outflow surface 13, 23 of the filter medium body 11, 21 of the respective filter element 1, 2. The seal profile 151, 251 of the circumferentially extending seals 15, 25 is formed as one piece together with the longitudinal legs 155, 255 and transverse legs 154, 254. The seal profile 151, 251 protrudes in radial direction R past the filter medium body 11, 21 of the respective filter element 1, 2. By means of the longitudinal legs 155, 255 and transverse legs 154, 254, the seal profile 15, 25 is reliably and seal-tightly held at the filter medium body 11, 21 of the respective filter element 1, 2. The longitudinal legs 155, 255 and transverse legs 154, 254 may be produced by means of foaming a flowable and curable seal material onto the filter medium bodies 11, 12.

The seal profile 151 of the circumferentially extending seal 15 of the first filter element 1 has a circumferentially extending groove 152 which at its groove bottom the circumferentially extending housing seal surface 311 of the first housing part 31 rests. The seal profile 251 of the circumferentially extending seal 25 of the second filter element 2 has a circumferentially extending groove 252 which at its groove bottom the first circumferentially extending seal surface 41 of the adapter frame 4 rests.

The seal profile 151 of the circumferentially extending seal 15 of the first filter element 1 comprises an axial seal surface 153 which is facing away from the circumferentially extending groove 152 and at which the second seal surface 42 of the adapter frame 40 rests. The seal profile 251 of the circumferentially extending seal 25 of the second filter element 2 comprises an axial seal surface 253 which is facing away from the circumferentially extending groove 252 and at which the circumferentially extending housing seal surface 321 of the second housing part 32 rests.

The receiving chamber 45 of the adapter frame 4 which is radially outwardly delimited by the collar section 44 comprises an acute angle 441 in relation to the axial direction A. In this way, on the one hand, mounting is facilitated because the angularly oriented collar section 44 serves as a mounting ramp; on the other hand, a combined radial-axial sealing action of the circumferentially extending seal 15 of the first filter element 1 may be realized at the angularly oriented collar section 44 when in embodiments an outer wall surface of the circumferentially extending seal 15 is brought into contact thereat.

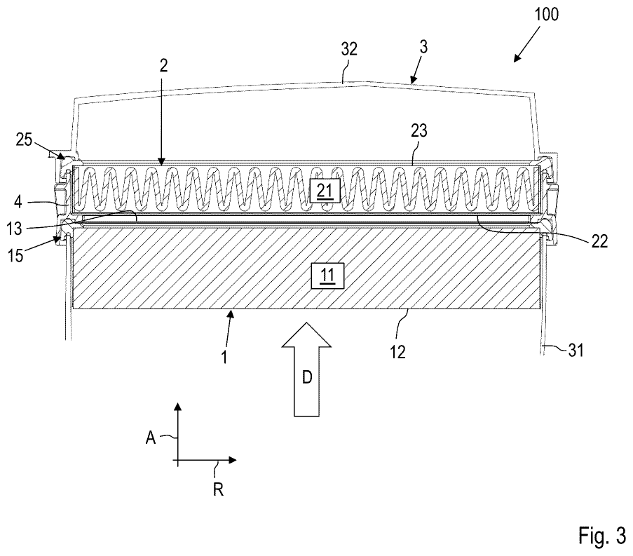

FIG. 3 shows the filter apparatus 100 according to the invention in a longitudinal section view, wherein the section plane S2 on which it is based is illustrated in FIG. 4, i.e., the section plane extends parallel to the long side of the filter housing 3.

In FIG. 4, the first filter element 1, the second filter element 2 as well as the adapter frame 4 of the filter apparatus 100 according to the invention are illustrated without the filter housing 3. It may be seen here that the adapter frame 4 has distributed about its circumference a plurality of guide devices 52 for the connection device 5 (see FIG. 1).

Based on the apparatus components illustrated in FIG. 4, the course of action for installation in the filter housing is as in the method described in the following for installation of filter elements in a filter apparatus according to the invention:
inserting the first filter element 1 into the filter element receptacle 312 of the first housing part 31, thereby bringing into contact the circumferentially extending seal 15 of the first filter element 1 at the circumferentially extending housing seal surface 311 of the first housing part;
placing the adapter frame 4 onto the first filter element 1, thereby bringing into contact the second circumferentially extending seal surface 42 of the adapter frame 4 at the circumferentially extending seal 15 of the first filter element;
placing the second filter element 2 onto the adapter frame 4, thereby bringing into contact the circumferentially extending seal 25 of the second filter element 2 at the first circumferentially extending seal surface 41 of the adapter frame 4;
placing the second housing part 32 onto the second filter element 2, thereby bringing into contact the circumferentially extending housing seal surface 321 of the second housing part 32 at the circumferentially extending seal 25 of the second filter element.

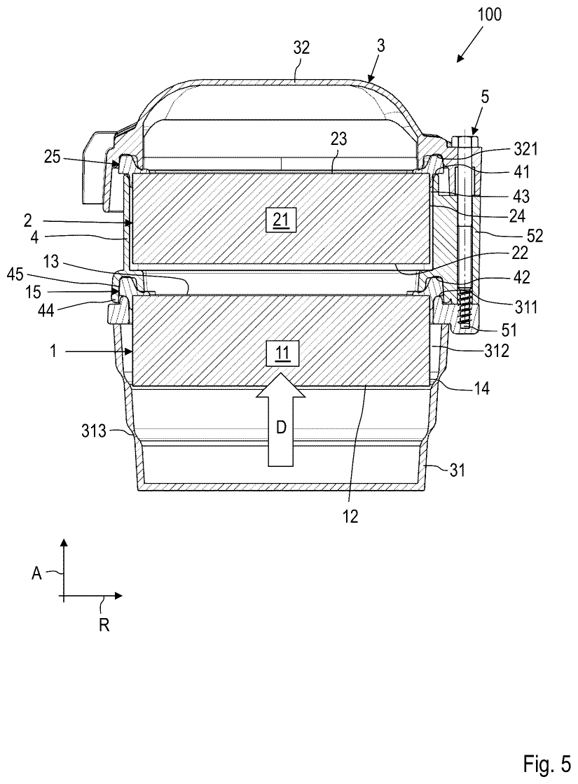

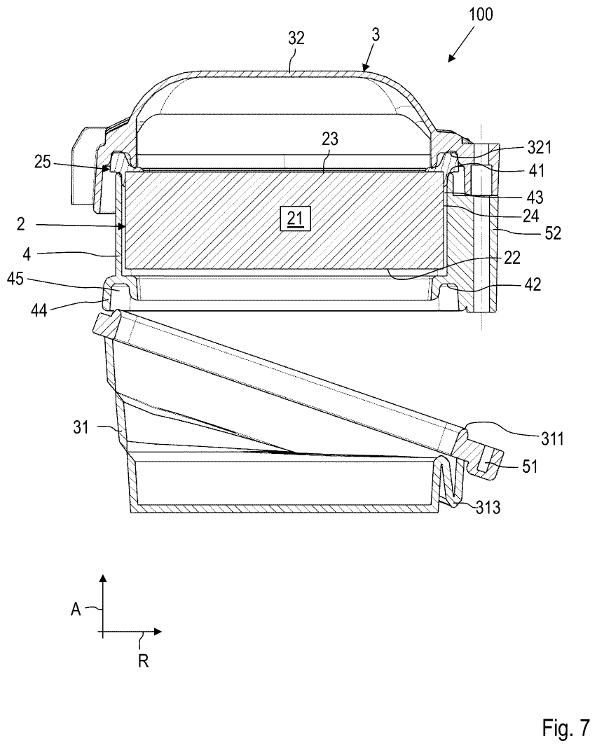

The filter apparatus 100 shown in FIG. 5 through FIG. 7 according to a further embodiment corresponds substantially to the first one illustrated in FIGS. 1 through 4, for which reason only the differences will be explained in the following.

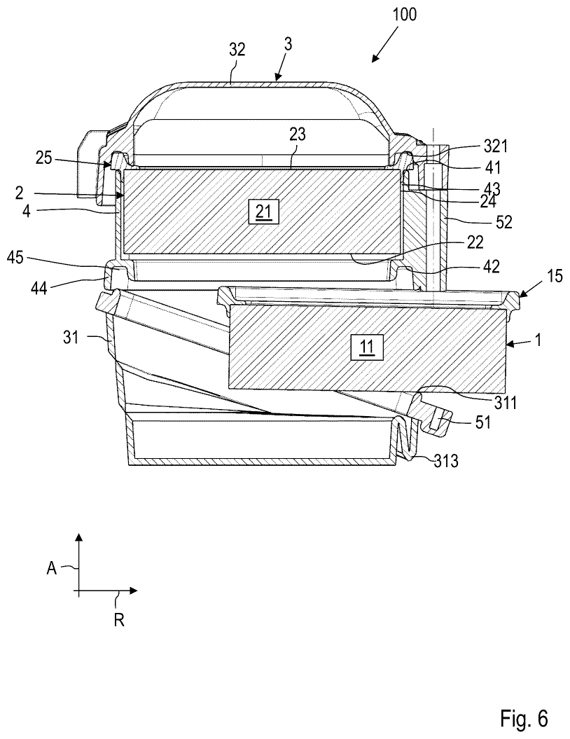

The main difference resides in that the housing base part 31 is configured to be collapsible. For this purpose, one wall of the housing base part 31 comprises two circumferentially extending yielding sections 313 arranged spaced apart from each other in flow direction D and along which the housing base part 31 may be folded opposite to the flow direction D when servicing the filter element. The service state with the wall of the housing base part 31 collapsed at least at one side is illustrated in FIG. 6. In this way, it is enabled that the first filter element 1 may be exchanged from below even in tight installation space conditions without the housing base part 31 having to be removed from the installation space. Due to the wall of the housing base part 31 collapsed at least at one side, a free space between the housing seal surface 311 of the housing base part 31 and the collar section 44 of the adapter frame 4 is created through which the first filter element 1 may be removed without problems.

The yielding sections 313 are provided so as to extend circumferentially at the wall of the housing base part 31 and are formed of a more yielding or flexible material than the rest of the wall. In this way, it is enabled that the yielding sections essentially act as film hinges along which the housing base part 31 may be folded. In a collapsed state of the housing base part 31, the yielding sections therefore form folds which are formed so as to extend in opposite directions.

In order to optimize the collapsibility, an extension of the housing base part 31 may decrease in axial direction opposite to the flow direction D so that the housing base part 31 is telescoping in order to achieve the envisioned reduction of the extension in the collapsed state in or opposite to the flow direction D.

Reference Characters

| | |
|---|---|
| 100 | filter apparatus |
| 1 | first filter element |
| 11 | first filter medium body |
| 12 | inflow side of the first filter element |
| 13 | outflow side of the first filter element |
| 14 | frame of the first filter element |
| 15 | circumferentially extending seal of the first filter element |
| 151 | seal profile |
| 152 | circumferentially extending groove |
| 153 | axial seal surface |
| 154 | transverse leg |
| 155 | longitudinal leg |
| 2 | second filter element |
| 21 | second filter medium body |
| 22 | inflow side of the second filter element |
| 23 | outflow side of the second filter element |
| 24 | frame of the second filter element |
| 25 | circumferentially extending seal of the second filter element |
| 251 | seal profile |
| 252 | circumferentially extending groove |
| 253 | axial seal surface |
| 254 | transverse leg |
| 255 | longitudinal leg |
| 3 | filter housing |
| 31 | first housing part |
| 311 | housing seal surface of the first housing part |
| 312 | filter element receptacle of the first housing part |
| 313 | yielding section/fold |
| 32 | second housing part |
| 321 | housing seal surface of the second housing part |
| 4 | adapter frame |
| 41 | first seal surface of the adapter frame |
| 42 | second seal surface of the adapter frame |
| 43 | filter element receptacle of the adapter frame |
| 44 | collar section of the adapter frame |
| 441 | angle of the collar section |
| 45 | receptacle chamber |
| 5 | connection device/screw |
| 51 | thread/bore |
| 52 | guide device |
| A | axial direction |
| D | flow direction |
| R | radial direction |
| S1, S2 | section planes |

What is claimed is:

1. A filter apparatus comprising:
a first filter element comprising a first filter medium body and a first seal circumferentially extending around the first filter medium body;
a second filter element comprising a second filter medium body and a second seal circumferentially extending around the second filter medium body;
a filter housing comprising a first housing part and a second housing part, wherein the first housing part comprises a filter element receptacle in which the first filter element is arranged, wherein the first housing part comprises a first circumferentially extending housing seal surface at which the first seal of the first filter element rests seal-tightly;
an adapter frame comprising a filter element receptacle in which the second filter element is arranged;
wherein the adapter frame comprises a first circumferentially extending seal surface at which the second seal of the second filter element rests seal-tightly;
wherein the adapter frame comprises a second circumferentially extending seal surface at which the first seal of the first filter element rests seal-tightly; and
wherein the second housing part comprises a second circumferentially extending housing seal surface at which the second seal of the second filter element rests seal-tightly.

2. The filter apparatus according to claim 1, wherein the first filter element is sealed indirectly in relation to the second housing part through the adapter frame and wherein the second filter element is sealed indirectly to the first housing part through the adapter frame.

3. The filter apparatus according to claim 1, wherein the first circumferentially extending seal surface of the adapter frame and the second circumferentially extending seal surface of the adapter frame are spaced apart from each other in an axial direction of the filter apparatus and are oriented facing away from each other.

4. The filter apparatus according to claim 3, wherein the adapter frame comprises a radially outwardly displaced, at least partially circumferentially extending collar section disposed adjacent to one of the first and second circumferentially extending seal surfaces and extending in the axial direction, and wherein the collar section delimits at least partially a receptacle chamber for the first seal or the second seal, respectively.

5. The filter apparatus according to claim 4, wherein the first seal comprises a first seal profile protruding radially past the first filter medium body and/or the second seal comprises a second seal profile protruding radially past the second filter medium body.

6. The filter apparatus according to claim 5, wherein the collar section of the adapter frame projects past the first seal profile and/or past the second seal profile in the axial direction.

7. The filter apparatus according to claim 5, wherein the first seal profile of the first seal comprises a circumferentially extending groove comprising a groove bottom, and wherein the first circumferentially extending housing seal surface of the first housing part rests at the groove bottom.

8. The filter apparatus according to claim 7, wherein the first seal profile of the first seal comprises an axial seal surface facing away from the circumferentially extending groove, and wherein the second circumferentially extending seal surface of the adapter frame rests at the axial seal surface.

9. The filter apparatus according to claim 5, wherein the second seal profile of the second seal comprises a circumferentially extending groove comprising a groove bottom, and wherein the first circumferentially extending seal surface of the adapter frame rests at the groove bottom.

10. The filter apparatus according to claim 9, wherein the second seal profile of the second seal comprises an axial seal surface facing away from the circumferentially extending groove, and wherein the second circumferentially extending housing seal surface of the second housing part rests at the axial seal surface.

11. The filter apparatus according to claim 4, wherein the collar section of the adapter frame extends at an acute angle in relation to the axial direction.

12. The filter apparatus according to claim 1, wherein the first housing part is a housing base part and the second housing part is a removable housing cover, and wherein the housing base part is arranged such that, as viewed in the axial direction away from the housing base part, the first filter element, the adapter frame, the second filter element, and the housing cover are positioned sequentially above the housing base part.

13. The filter apparatus according to claim 12, wherein the first filter element is exchangeable from below by removal of the housing base part and the second filter element is exchangeable from above by removal of the housing cover.

14. The filter apparatus according to claim 1, further comprising a connection device connecting the first housing part to the second housing part and generating a pretension force oriented at least in an axial direction of the filter apparatus.

15. The filter apparatus according to claim 14, wherein the adapter frame comprises a guide device coupled to the connection device and configured to guide the connection device in at least one direction relative to the axial direction.

16. The filter apparatus according to claim 1, wherein the first filter medium body and/or the second filter medium body comprises at least one particle filter medium, and wherein the at least one particle filter medium is selected from the group consisting of a synthetic nonwoven material and a cellulose-based filter medium.

17. The filter apparatus according to claim 1, wherein the first filter medium body and/or the second filter medium body comprises at least one gas filter medium, and wherein the at least one gas filter medium is an adsorber selected from the group consisting of an active carbon, a zeolite, and an ion exchanger.

18. The filter apparatus according to claim 1, wherein the first housing part and/or the second housing part is configured to collapse such that an extension of the first housing part and/or the second housing part is reducible at least in or opposite to a flow direction through the filter apparatus to enable an exchange of at least one of the first filter element and the second filter element.

19. A method of using a filter element, comprising a filter medium body and a seal circumferentially extending around the filter medium body, as a first filter element in the filter apparatus according to claim 1, the method comprising:
contacting the seal circumferentially extending around the filter medium body seal-tightly at the second seal surface of the adapter frame, and
contacting the seal circumferentially extending around the filter medium body seal-tightly at the circumferentially extending housing seal surface of the first housing part.

20. A method of using a filter element, comprising a filter medium body and a seal circumferentially extending around the filter medium body, as a second filter element in the filter apparatus according to claim 1, the method comprising:
contacting the seal circumferentially extending around the filter medium body seal-tightly at the first seal surface of the adapter frame, and
contacting the seal circumferentially extending around the filter medium body seal-tightly at the circumferentially extending housing seal surface of the second housing part.
